(19) United States
(12) Patent Application Publication
(10) Pub. No.: US 2004/0259404 A1
(43) Pub. Date: Dec. 23, 2004

(54) Memory card connector with improved switch terminals

(76) Inventor: Chia-Chen Chang, Hsin Chung City (TW)

Correspondence Address: MOLEX INCORPORATED, 2222 WELLINGTON COURT, LISLE, IL, 60532, US

(21) Appl. No.: 10/869,611

(22) Filed: Jun. 16, 2004

(30) Foreign Application Priority Data
Jun. 17, 2003 (TW) 92211038

(51) Int. Cl. H01R 29/00

(52) U.S. Cl. 439/188

(57) ABSTRACT

A memory card connector includes an insulative housing having a rear terminal-mounting section and at least one side wall section extending forwardly from one end of the rear section defining a card-receiving space therebetween. A first switch terminal is mounted on the housing and has a first contact portion at the card-receiving space. A second switch terminal is mounted on the housing and has a second contact portion at the card-receiving space. A third switch terminal is mounted on the housing and has a pair of third contact portions engageable by the first and second contact portions of the first and second switch terminals, respectively, in response to inserting a memory card into the card-receiving space. The third switch terminal is a generally planar plate-like member. The third switch terminal includes a central body portion and a pair of connecting arms projecting from opposite sides of the central body portion. A pair of contact spring arms extend back over the connecting arms from distal ends thereof. Free ends of the contact spring arms form the third contact portions.

### FIELD OF THE INVENTION

This invention generally relates to the art of electrical connectors and, particularly, to a memory card connector.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like.

Some memory card connectors are provided with a write-protection function by means of a pair of elastic conductive terminals forming a controlling switch. The two switch terminals are mounted at a side of the connector and have respective elastic arms arranged in close proximity to each other and may be moved into mutual engagement by the memory card to close the controlling switch. Some memory card connectors also are provided with a card detector function by means of a third switch terminal which may be moved into engagement with one of the other switch terminals by a memory card, such as by a leading edge of the card. This indicates or detects that the card is fully inserted into the connector.

FIG. 1 shows a conventional memory card connector, generally designated 10, of the character described. The connector includes an insulative housing, generally designated 12, which mounts a plurality of terminals, generally designated 14. The housing has a rear terminal-mounting section 16, along with a pair of side wall sections 18 to define a generally U-shaped configuration. A generally flat or planar base 20 spans side wall sections 18 at the bottoms thereof forwardly of the rear terminal-mounting section 16. Typically, a metal shell (not shown) is mounted on top of the housing and combines therewith to define an interior cavity 22 for receiving a memory card inserted into the cavity in the direction of arrow “A” between side wall sections 18 of the housing and above base 20. Appropriate contacts on the memory card engage cantilevered contact portions 14a of connector terminals 14. The contact portions extend forwardly into the cavity. The connector is adapted for mounting on a printed circuit board, and the connector terminals include tail portions 14b for connection, as by soldering, to appropriate circuit traces on the board.

Prior art connector 10 includes a write-protection function and a first switch terminal (not shown) is mounted in a first slot 24 in one of the side wall sections 18 of the housing. The connector includes a card detector function, and a second switch terminal, generally designated 26, is mounted in a second slot 28 in the rear terminal-mounting section 16 of the housing. A third switch terminal, generally designated 30, is L-shaped and is mounted in an L-shaped slot 32 which extends into both the rear terminal-mounting section and the one side wall section of the housing. Second switch terminal 26 includes a resilient contact arm 26a which is angled forwardly into cavity 22 in front of a resilient contact arm 30a of third switch terminal 30.

When a memory card is inserted into cavity 22 of prior art connector 10, a side edge of the memory card engages a contact arm of the first switch terminal (not shown) and biases the arm into engagement with a resilient contact arm 30b of third switch terminal 30. This closes the “switch” defined by the first and third switch terminals to effect the write-protection function.

When the memory card is inserted fully into cavity 22, a leading edge of the memory card engages resilient contact arm 26a of second switch terminal 26 and biases the contact arm into engagement with resilient contact arm 30a of third switch terminal 30. This automatically closes the “switch” defined by the second and third switch terminals to effect the card detector function of the connector.

Problems continue to be encountered with prior art connectors as described above and as shown in FIG. 1. The first switch terminal is configured significantly different from the second switch terminal which, in turn, is configured significantly different from the third switch terminal. All of these different configurations lead to manufacturing complications and increased costs. It can be seen that the configurations of the various switch terminals, particularly the bending and forming of the second and third switch terminals, are quite complicated and lead to twisting and bending of the contact arms which, in turn, leads to bad conduction between the terminals and inferior connections. The contact areas of the terminals are not secure, and the pivot forces are highly concentrated for such relatively large or long terminals. The present invention is directed to solving these various problems.

### SUMMARY OF THE INVENTION

An object, therefore, of the invention is to provide a new and improved memory card connector of the character described and having improved switch terminals mounted on the connector housing.

In the exemplary embodiment of the invention, the connector includes an insulative housing having a rear terminal-mounting section and at least one side wall section extending forwardly from one end of the rear section defining a card-receiving space therebetween. A first switch terminal is mounted on the housing and has a first contact portion at the card-receiving space. A second switch terminal is mounted on the housing and has a second contact portion at the card-receiving space. A third switch terminal is mounted on the housing and has a pair of third contact portions engageable by the first and second contact portions of the first and second switch terminals in response to inserting a memory card into the card-receiving space,. The third switch terminal is a generally planar plate-like member. The third switch terminal includes a central body portion and a pair of connecting arms projecting from opposite sides of the central body portion. A pair of contact spring arms extend back over the connecting arms from distal ends thereof. Free ends of the contact spring arms form the third contact portions.

According to one aspect of the invention, the free ends of the contact spring arms of the third switch terminal comprise enlarged planar contact pads. The contact pads, along with the contact spring arms, the connecting arms and the central body portion all are flat, coplanar components of the planar plate-like third switch terminal. In addition, the insulative housing may be adapted for mounting on a printed circuit board. Correspondingly, the third switch terminal may include a tail portion for connection to an appropriate termination pad on the circuit board.

According to another aspect of the invention, the third switch terminal and at least one of the first and second switch terminals are mounted on the side wall section of the insulative housing. The third switch terminal is mounted in a slot in a bottom surface of the side wall section. The at least one of the first and second switch terminals is mounted in slot means in the side wall section and includes a card engaging portion projecting into the card-receiving space through a window in the side wall section, with the window communicating with the slot means.

According to a further aspect of the invention, the at least one of the first and second switch terminals includes a main body portion fixed to the housing. A contact spring arm is cantilevered from the main body portion. A free end of the contact spring arm has a planar contact portion for engaging a respective one of the third contact portions of the third switch terminal. The card engaging portion is located immediately inside the planar contact portion for projecting into the card-receiving space.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures. and in which:

FIG. 1 is a perspective view of a memory card connector according to the prior art and as described in the Background, above;

FIG. 2 is a fragmented perspective view of a side wall section of a housing of a memory card connector, along with three switch terminals, according to the invention;

FIG. 3 is a bottom plan view of the side wall section;

FIG. 4 is a side elevational view of the side wall section;

FIG. 5 is a perspective view similar to that of FIG. 2, with the three switch terminals mounted in the side wall section;

FIG. 6 is a perspective view looking toward the inside of the assembled side wall section, in conjunction with a memory card; and

FIG. 7 is a view similar to that of FIG. 6, with the memory card inserted into the connector.

### DETAILED DESCRIPTION OF THE PREFERRED EMBODIMENT

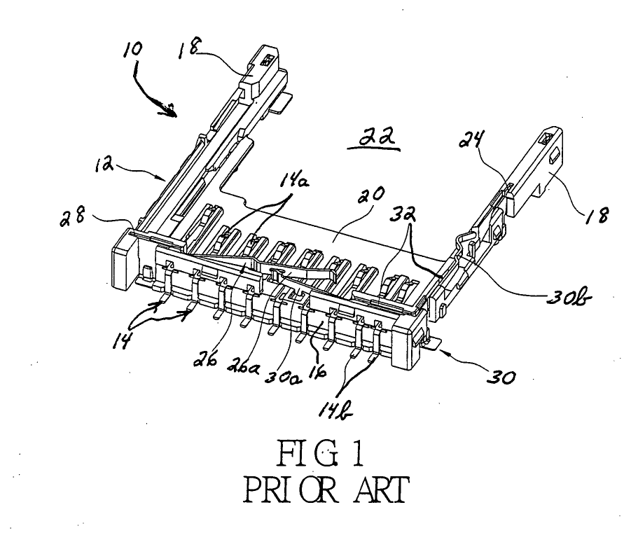

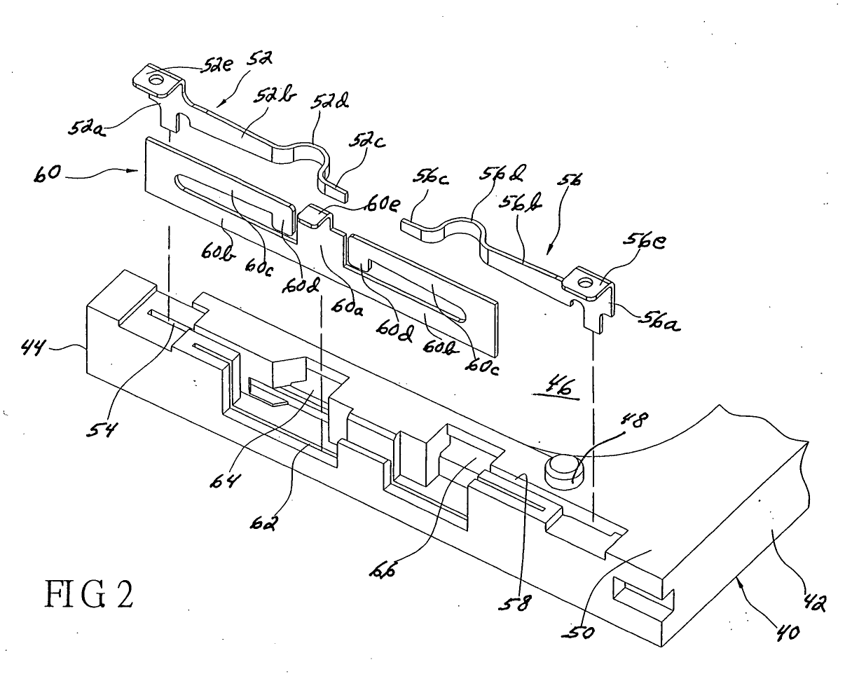

Referring to the drawings in greater detail, and first to FIG. 2, the invention is embodied in a memory card connector which includes an insulative housing, generally designated 40, which has an overall configuration similar to that described above in relation to the prior art connector in FIG. 1. In other words, housing 40 includes a rear terminal-mounting section 42 and at least one side wall section 44 extending forwardly from one end of the rear section defining a card-receiving space 46 for receiving a memory card. The housing is adapted for mounting on a printed circuit board and includes one or more mounting posts 48 projecting downwardly from a bottom surface 50 of the housing including the side wall section.

As is known in the art and as shown in FIG. 1, a plurality of conductive terminals (not shown) are mounted on rear terminal-mounting section 42 of housing 40. In addition, a second side wall section may extend forwardly from the opposite end of the rear section to form the housing in a generally U-shaped configuration. Alternatively, the housing may have a L-shaped configuration with only the one side wall section 44.

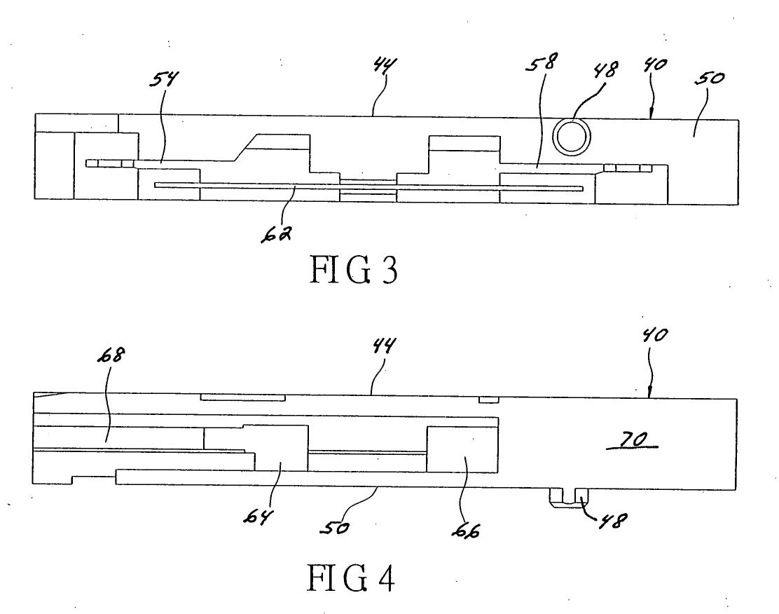

In any event, the memory card connector of the invention includes a first switch terminal, generally designated 52, which is mounted in a slot 54 in bottom surface 50 of side wall section 44. A second switch terminal, generally designated 56, is mounted in a slot 58 in bottom surface 50. A third switch terminal, generally designated 60, is mounted in a slot 62 in the side wall section. It can be seen in FIG. 3 that slots 54 and 58 for first and second switch terminals 52 and 56, respectively, are inside slot 62 for third switch terminal 60. For purposes to be described hereinafter, slot 54 has a window 64 and slot 58 has a window 66, with both windows communicating with the card-receiving space 46. FIG. 4 shows windows 64 and 66, along with a card sliding groove 68 in an inside surface 70 of side wall section 44.

Referring back to FIG. 2, first switch terminal 52 includes a body portion 52a fixed within slot 54 in the side wall section of the housing. A contact spring arm 52b is cantilevered from the body portion and terminates in a free end 52c which forms a planar first contact portion 52c. A rounded or convex card engaging portion 52d is located immediately inside the planar contact portion. Finally, a flat tail portion 52e extends generally perpendicularly to body portion 52a for connection, as by soldering, to an appropriate circuit trace on the printed circuit board.

Second switch terminal 56 is a mirror image of first switch terminal 52. Correspondingly, the second switch terminal includes a body portion 56a, a contact spring arm 56b cantilevered from the body portion, and a planar second contact portion 56c at the free end of the contact spring arm, along with a rounded or convex card engaging portion 56d. Second switch terminal 56 also includes a flat tail portion 56e.

Third switch terminal 60 is a generally planar plate-like member which is configured symmetrically about a central body portion 60a. A pair of connecting arms 60b project from opposite sides of the central body portion. A pair of contact spring arms 60c extend back over the connecting arms from distal ends thereof. Free ends of the contact spring arms form third contact portions 60d. It can be seen in FIG. 2 that the third contact portions 60d at the free ends of contact spring arms 60c are enlarged planar contact pads. The contact pads, along with contact spring arms 60c, connecting arms 60b and central body portion 60a all are flat, coplanar components of the planar plate-like third switch terminal 60. Finally, a flat tail portion 60e extends perpendicularly to the central body portion for connection, as by soldering, to an appropriate termination pad or circuit trace on the printed circuit board.

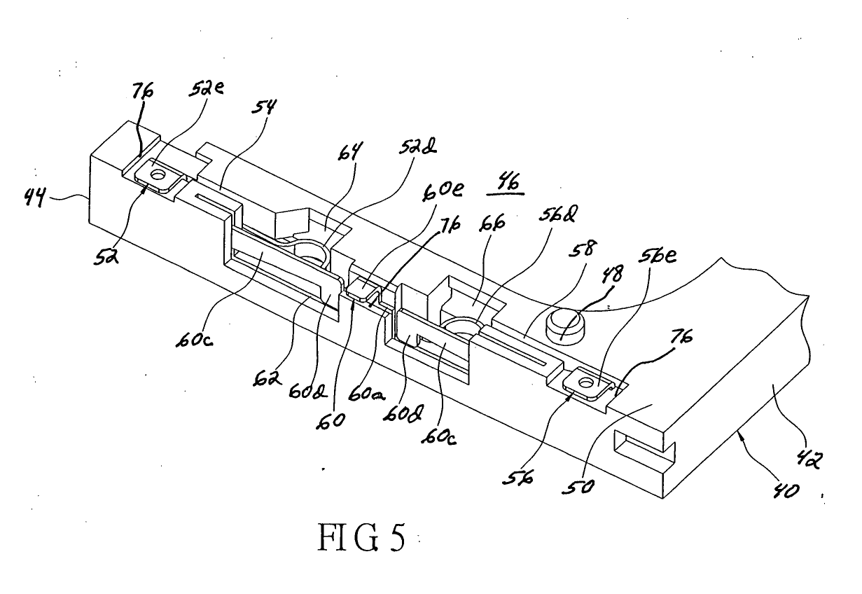

FIG. 5 shows first switch terminal 52, second switch terminal 56 and third switch terminal 60 mounted in first slot 54, second slot 58 and third slot 62, respectively, in bottom surface 50 of side wall section 44 of housing 40. Flat tail portions 52e, 56e and 60e of the terminals are located within recesses 76 in the bottom surface of the housing so that the flat tail portions are generally flush with the bottom surface. FIG. 5 shows that convex card engaging portions 52d and 56d of the first and second switch terminals 52 and 56, respectively, are aligned with windows 64 and 66, respectively. Although not visible in FIG. 5, planar contact portions 52c and 56c of the first and second switch terminals 52 and 56, respectively, are located behind and spaced inwardly of the enlarged planar contact pads 60d of the third switch terminal 60.

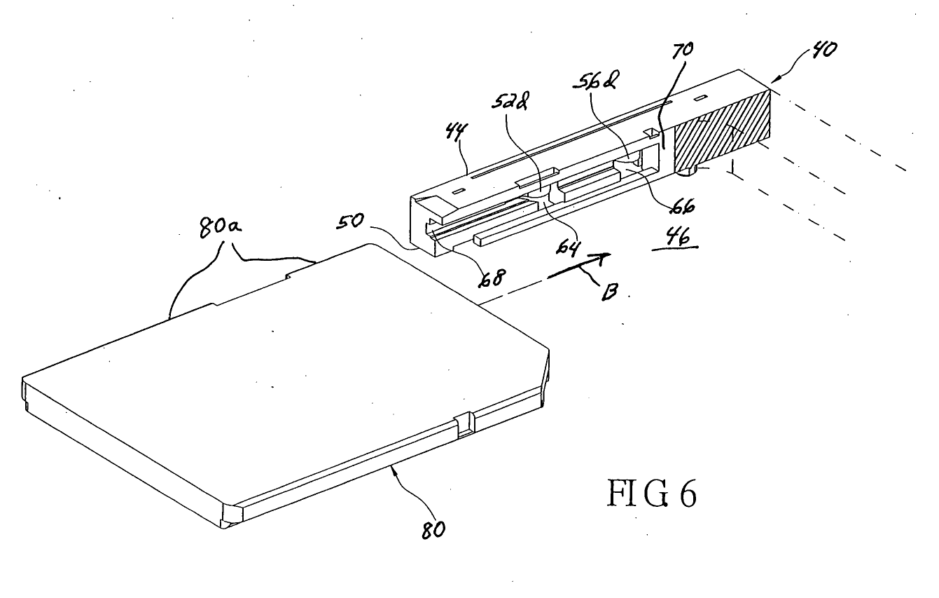

FIG. 6 shows a memory card, generally designated 80, about to be inserted into the card-receiving space 46 of housing 40. Card sliding groove 68 in inside surface 70 of side wall section 44 can be seen in this depiction. Actually, the card sliding groove is a side extension of card-receiving space 46. It can be seen that windows 64 and 66 communicate or open inwardly at the card-receiving space. The convex card engaging portions 52d and 56d of the first and second switch terminals, respectively, project through windows 64 and 66, respectively, and into the card sliding groove 68 of card-receiving space 46.

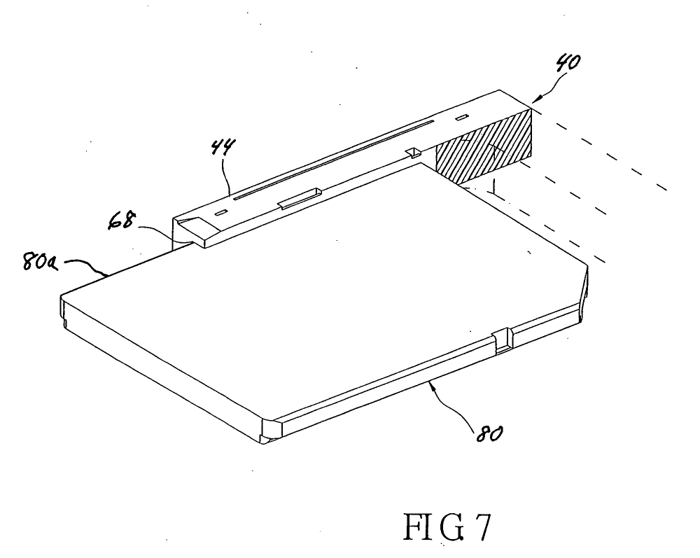

When memory card 80 is inserted into the card-receiving space 46 in the direction of arrow “B” FIG. 6), a side edge 80a of the card rides into the card sliding groove 68 as shown in FIG. 7. The side edge of the card sequentially engages card engaging portion 52d and then card engaging portion 56d of the first and second switch terminals, respectively. This biases spring contact arms 52b and 56b of the first and second switch terminals, respectively, outwardly. In turn, planar contact portions 52c and 56c of the first and second switch terminals, respectively, engage the enlarged planar contact pads 60b of third switch terminal 60. The movement of the card effectively actuates the write-protection function of the connector afforded by first switch terminal 52 engaging third switch terminal 60, and then effectively actuates the card detector function of the connector afforded by second switch terminal 56 and third switch terminal 60 as memory card 80 reaches the fully inserted position of FIG. 7.

With third switch terminal 60 being a planar plate-like member, it is extremely simple to manufacture by a single stamping step on sheet metal material, with tail portion 60e being the only component that needs to be formed. With the third switch terminal being symmetrical about central body portion 60a, the final termination condition of the terminal when the memory card is fully inserted, does not create any twisting or turning stress on the terminal. The flat structure of the terminal is very strong. The planar contacts pads 60d of the terminal can be made large for significant contact engagement with the flat planar contact portions 52c and 56c of the first and second switch terminals, respectively.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A memory card connector, comprising:
an insulative housing have a rear terminal-mounting section and at least one side wall section extending forwardly from one end of the rear section defining a card-receiving space therebetween;
a first switch terminal mounted on the housing and having a first contact portion;
a second switch terminal mounted on the housing and having a second contact portion; and
a third switch terminal mounted on the housing and having a pair of third contact portions engageable by the first and second contact portions of the first and second switch terminals, respectively, in response to inserting a memory card into the card-receiving space, the third switch terminal being a generally planar plate-like member and including
a central body portion,
a pair of connecting arms projecting from opposite sides of the central body portion,
a pair of contact spring arms extending back over the connecting arms from distal ends thereof,
and free ends of said contact spring arms forming said third contact portions.

2. The memory card connector of claim 1 wherein the free ends of said contact spring arms comprise enlarged planar contact pads.

3. The memory card connector of claim 2 wherein said contact pads, said contact spring arms, said connecting arms and said central body portion all are flat, coplanar components of the planar plate-like third switch terminal.

4. The memory card connector of claim 1 wherein said insulative housing is adapted for mounting on a printed circuit board, and the third switch terminal includes a tail portion for connection to an appropriate termination pad on the circuit board.

5. The memory card connector of claim 1 wherein said third switch terminal and at least one of said first and second switch terminals are mounted on the side wall section of the insulative housing.

6. The memory card connector of claim 5 wherein said third switch terminal is mounted in a slot in a bottom surface of the side wall section.

7. The memory card connector of claim 5 wherein said at least one of the first and second switch terminals is mounted in slot means in the side wall section and includes a card engaging portion projecting into the card-receiving space through a window in the side wall section, the window communicating with said slot means.

8. The memory card connector of claim 5 wherein said at least one of the first and second switch terminals includes a body portion fixed to the housing, a contact spring arm cantilevered from the body portion, and a free end of the contact spring arm having a planar contact portion for engaging a respective one of the third contact portions of the third switch terminal.

9. The memory card connector of claim 8 wherein said at least one of the first and second switch terminals includes a card engaging portion immediately inside the planar contact portion thereof and projecting with the card-receiving space.

10. A memory card connector, comprising:
an insulative housing have a rear terminal-mounting section and at least one elongated side wall section extending forwardly from one end of the rear section defining a card-receiving space therebetween, a bottom surface of the elongated side wall section including first and second longitudinally spaced slots and a third slot spanning the first and second slots and spaced outwardly thereof;
a first switch terminal having a body portion mounted in the first slot in the housing and including a contact spring arm cantilevered from the body portion, a free end of the contact spring arm having a first planar contact portion, and a card engaging portion projecting into the card-receiving space;
a second switch terminal having a body portion mounted in the second slot in the housing and including a contact spring arm cantilevered from the body portion, a free end of the contact spring arm having a second planar contact portion, and a card engaging portion projecting into the card-receiving space; and
a third switch terminal mounted in the third slot in the housing and having a pair of third contact portions engageable by the first and second contact portions of the first and second switch terminals, respectively, in response to inserting a memory card into the card-receiving space into engagement with the card engaging portions of the first and second switch terminals, the third switch terminal being a generally planar plate-like member and including
a central body portion,
a pair of connecting arms projecting from opposite sides of the central body portion,
a pair of contact spring arms extending back over the connecting arms from distal ends thereof,
and free ends of said contact spring arms forming said third contact portions.

11. The memory card connector of claim 10 wherein the free ends of said contact spring arms of the third switch terminal comprise enlarged planar contact pads.

12. The memory card connector of claim 11 wherein said contact pads, said contact spring arms, said connecting arms and said central body portion all are flat, coplanar components of the planar plate-like third switch terminal.

13. The memory card connector of claim 10 wherein said side wall section includes a pair of windows communicating with said first and second slots and through which the card engaging portions of the first and second switch terminals project into the card-receiving space.
